(19) United States
(12) Patent Application Publication
(10) Pub. No.: US 2024/0114283 A1
(43) Pub. Date: Apr. 4, 2024

(54) EARPHONE EAR-HOOK STRUCTURE

(71) Applicant: YI ZHAO ( SHENZHEN ) CO., LIMITED, SHENZHEN (CN)

(72) Inventors: CHAOSHENG WANG, SHENZHEN (CN); XIAOLIN LI, SHENZHEN (CN)

(21) Appl. No.: 17/955,710

(22) Filed: Sep. 29, 2022

(51) Int. Cl. H04R 1/10

(52) U.S. Cl. CPC H04R 1/105

(57) ABSTRACT

An earphone ear-hook structure capable of bidirectionally rotating includes an earphone housing and an ear hook. The earphone housing and the ear hook are rotatably connected through a rotatable damping structure. The rotatable damping structure is configured to adjust a range of an included angle between the earphone housing and the ear hook. The ear hook is hung at ear backs of ears, the range of the included angle between the ear hook and the earphone housing is adjusted by adjusting and rotating the ear hook, and a degree of opening of the included angle is controlled through turning and reversing. A large degree of opening is suitable for people with large ears, while a small degree of opening is suitable for people with small ears, and the earphone ear-hook structure matches with different ear shapes and ear sizes, which is comfortable and stable to wear.

### TECHNICAL FIELD

The present disclosure relates to a technical related field of earphones, and in particular to an earphone ear-hook structure capable of bidirectionally rotating.

### BACKGROUND

Currently, earphones are very common electronic devices. The current earphones are provided with an ear-hook structure to better increase wearing stability. Especially, the earphones with the ear-hook structure have more advantages in sports. The current earphones with the ear-hook structure each includes an ear-hook part and a housing of an earphone body part, where the ear-hook part and the housing of the earphone body part are integrally fixed, and adjustability of which is poor. Manufacturers mostly produce general-purpose earphones having ear-hook structure, since different people have different body structures with different ear shapes and sizes, and ear hooks may not exactly match with ears of some people when the people wear the earphones, the ear-hook structure of the earphones is unstable for matching the ears of the people, which leads to a risk of falling off.

In view of this, the present disclosure is proposed.

### SUMMARY

In order to solve above technical problems, a basic concept of technical scheme of the present disclosure is as follows:

An earphone ear-hook structure includes an earphone housing and an ear hook. The earphone housing and the ear hook are rotatably connected through a rotatable damping structure. The rotatable damping structure is configured to adjust a range of an included angle between the earphone housing and the ear hook.

Beneficial effects of the present disclosure are that when the ear hook is hung at ear backs of ears, the range of the included angle between the ear hook and the earphone housing is adjusted by adjusting and rotating the ear hook, and a degree of opening of the included angle is controlled through turning and reversing. A large degree of opening of the included angle is suitable for people with large ears, while a small degree of opening of the included angle is suitable for people with small ears, and the present disclosure adapts to different ear shapes and ear sizes, which is comfortable and stable to wear.

Specific embodiments of the present disclosure are further described in details below with reference to accompanying drawings.

### BRIEF DESCRIPTION OF DRAWINGS

FIG. 1 is a schematic diagram according to one embodiment of the present disclosure.

FIG. 2 is a first exploded schematic diagram according to one embodiment of the present disclosure.

FIG. 3 is a second exploded schematic diagram according to one embodiment of the present disclosure.

FIG. 4 is a third exploded schematic diagram according to one embodiment of the present disclosure.

FIG. 5 is a schematic diagram of an ear hook rotating along with a gear sleeve according to one embodiment of the present disclosure.

FIG. 6 is a schematic diagram of a sense of rotation of the ear hook according to one embodiment of the present disclosure.

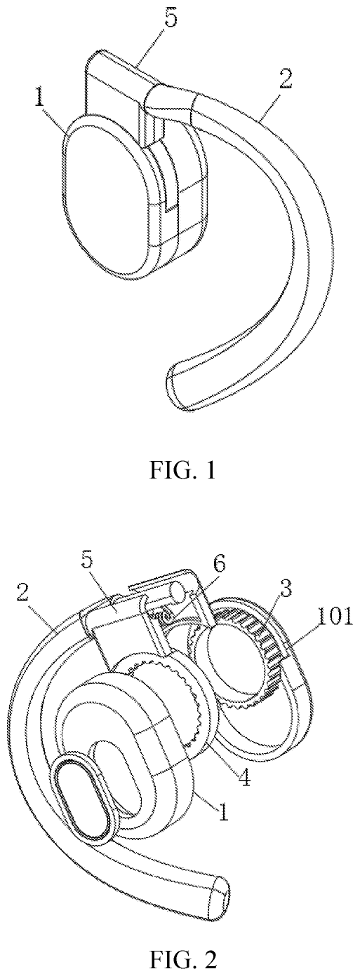

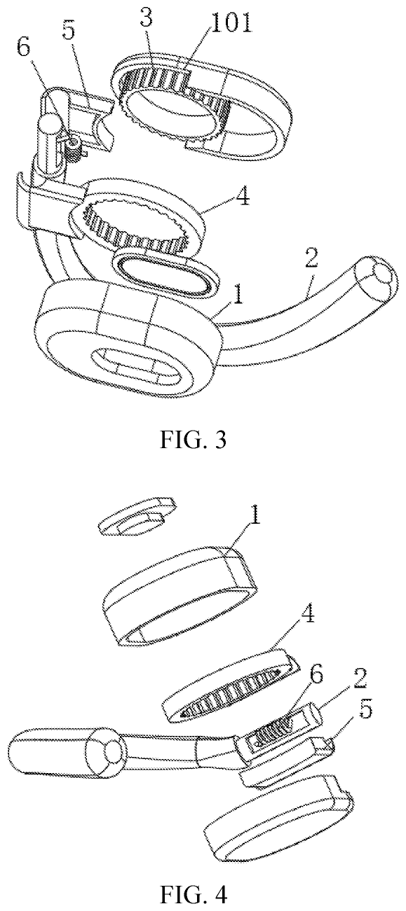

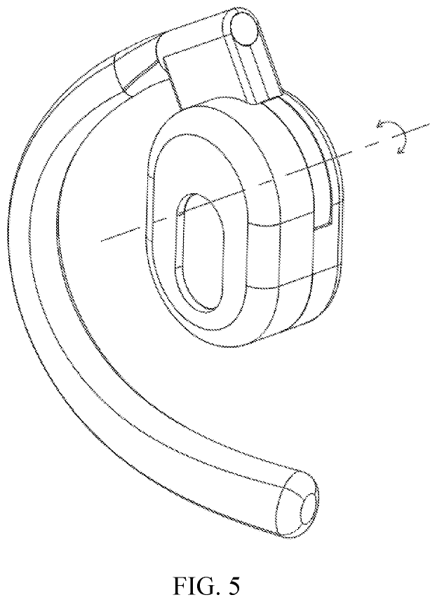

Reference number in the drawings: 1. earphone housing; 101. notch; 2. ear hook; 3. fixed gear; 4. gear sleeve; 5. connecting component; 6. torsion spring.

### DETAILED DESCRIPTION

In order to make objectives, technical solutions and advantages of embodiments of the present disclosure clearer, following clearly and completely describes the technical solutions in the embodiments with reference to accompanying drawings in the embodiments of the present disclosure.

### First Embodiment

When wearers wear earphones, the wearers select different people with larger ears and smaller ears. The ear hook 2 is hung at ear backs of ears, the range of the included angle between the ear hook 2 and the earphone housing 1 is adjusted by adjusting and rotating the ear hook 2, and a degree of opening of the included angle is controlled through turning and reversing. A large degree of opening of the included angle is suitable for people with large ears, while a small degree of opening of the included angle is suitable for people with small ears. A specific linkage relationship of rotation of the ear hook 2 is that when the ear hook 2 is shifted to rotate, the gear sleeve 4 rotates around the fixed gear 3 through the connecting component 5, a certain damping force is formed between the gear sleeve 4 and the fixed gear 3, and the damping force limits a state of the ear hook 2 after being adjusted. Optionally, the ear hook is made of soft materials, such as current soft materials of silicone, soft plastic, etc.

### Second Embodiment

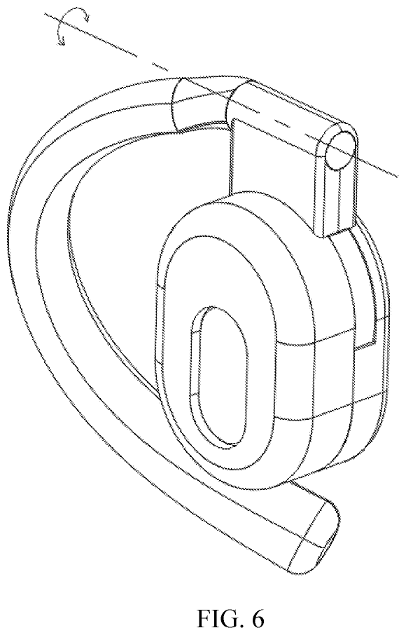

Difference between the second embodiment and the first embodiment is that the part of the connecting component is improved. Even though the ear hook 2 is made of the soft materials, during wearing, the ear hook 2 is shifted for rotation and further rotates to clamp at the ears of the wearers, and a clamping force near the included angle between the earphone housing 1 and the ear hook 2 is not enough. In order to further improve a matching degree, the connecting component 5 is designed to be of a housing structure. One end of the ear hook 2 penetrates into an interior of the connecting component 5 to be rotatably connected with the connecting component 5. A torsion spring clamping groove is formed between an inner part of the one end of the ear hook 2 penetrating into the connecting component 5 and an inner wall of the connecting component 5. A torsion spring 6 is clamped in the torsion spring clamping groove. A concave groove is formed at one side, opposite to the torsion spring 6, of the inner part of the one end of the ear hook 2 penetrating into the connecting component 5. One end of the torsion spring 6 is clamped into the concave groove. When the wearers wear the ear hook, the ear hook 2 is turned for adjustment and matching different shapes of the ears of the wearers, where turning the ear hook 2 is a rotation of the ear hook 2 with respect to the connecting component 5 as shown in FIG. 6. Reset capability of the torsion spring 6 limits the rotation of the ear hook 2 with respect to the connecting component 5. Since the clamping force is stable, the ear hook of the earphones is properly rotated as a whole during wearing, thereby adjusting a wearing position of the ear hook of the earphones on the ears, and a better wearing experience is further provided for a user wearing glasses.

The above shows and describes basic principles, main features, and advantages of the present disclosure. It should be understood by those skilled in art that the present disclosure is not limited by the above embodiments. The above embodiments and the description are merely illustrative of the principles of the present disclosure. Various changes and improvements are made in the present disclosure without departing from spirit and scope of the present disclosure, and the changes and the improvements fall within the scope of the present disclosure as claimed. The current present disclosure requires the scope of protection to be defined by the attached claims and effects thereof.

What is claimed is:

1. An earphone ear-hook structure, comprising:
an earphone housing; and
an ear hook;
wherein the earphone housing and the ear hook are rotatably connected through a rotatable damping structure, and the rotatable damping structure is configured to adjust a range of an included angle between the earphone housing and the ear hook.

2. The earphone ear-hook structure according to claim 1, wherein an interior of the earphone housing is of a cavity structure, a notch is defined at one side of the earphone housing; the rotatable damping structure comprises a fixed gear, the fixed gear is fixed in the earphone housing, an outer surface of the fixed gear is meshed with a gear sleeve, and the gear sleeve is partially and rotatably connected to a head position of one side end of the ear hook after penetrating through the notch.

3. The earphone ear-hook structure according to claim 2, wherein the gear sleeve and the ear hook are rotatably connected through a connecting component, a first end of the connecting component is rotatably connected to the head position of one side end of the ear hook, and a second end of the connecting component is connected to the gear sleeve.

4. The earphone ear-hook structure according to claim 3, wherein the connecting component is of a housing structure, one end of the ear hook penetrates into an interior of the connecting component to be rotatably connected with the connecting component, a torsion spring clamping groove is formed between an inner part of the one end of the ear hook penetrating into the connecting component and an inner wall of the connecting component, a torsion spring is clamped in the torsion spring clamping groove; a concave groove is formed at one side, opposite to the torsion spring, of the inner part of the one end of the ear hook penetrating into the connecting component; and one end of the torsion spring is clamped into the concave groove.

5. The earphone ear-hook structure according to claim 1, wherein the ear hook is made of soft materials.

6. The earphone ear-hook structure according to claim 2, wherein the ear hook is made of soft materials.

7. The earphone ear-hook structure according to claim 3, wherein the ear hook is made of soft materials.

8. The earphone ear-hook structure according to claim 4, wherein the ear hook is made of soft materials.
